(19) United States
(12) Patent Application Publication
(10) Pub. No.: US 2008/0256353 A1
(43) Pub. Date: Oct. 16, 2008

(54) Method and Apparatus for Hiding Information in Communication protocol

(75) Inventors: Ting-Kai Hung, Hsinchu County (TW); Jian-Chih Liao, Taichung County (TW); Tsai-Yuan Hsu, Tainan County (TW); Chih-Hao Cheng, Hsinchu City (TW); Ken-Li Chen, Hsinchu (TW)

Correspondence Address: WPAT, PC, 7225 BEVERLY ST., ANNANDALE, VA, 22003, US

(73) Assignee: VICOTEL, INC., Hsinchu (TW)

(21) Appl. No.: 11/839,516

(22) Filed: Aug. 15, 2007

(30) Foreign Application Priority Data
Apr. 16, 2007 (TW) 096113285

(51) Int. Cl. H04L 9/28; G06F 15/16; H04K 1/00; H04L 9/00

(52) U.S. Cl. 713/151; 380/259; 380/28; 726/14

(57) ABSTRACT

A method and apparatus for hiding information in a communication protocol signal are disclosed. The apparatus comprises a bit selection unit, an information encoding unit and an information decoding unit, wherein the bit selection unit selects suitable bits in the signal for hiding information, the information encoding unit encodes the information into the suitable bits selected by the bit selection unit, and the information decoding unit decodes the information encoded in the suitable bits.

### FIELD OF THE INVENTION

The present invention relates generally to a method and apparatus for hiding information, and more specifically related to a method and system for hiding information in a communication protocol signal.

### BACKGROUND OF THE INVENTION

Session Initiation Protocol (SIP) is a communication protocol of the Internet application layer. Conceptually, it is similar to HTTP and SMTP, but its primary purpose is a signaling control protocol in the Internet for establishing or terminating sessions between users. Moreover, SIP and its extensions also provide some related functions, such as instant message delivery, registration and status alert (presence).

SIP network may include user agents, and the servers at the system end may include elements such as SIP proxy servers, registrar, redirect servers, and SIP application servers. The user agents can be softphones, instant message transceivers, IP phones, or even mobile phones or any communication devices supporting the SIP protocol.

Since SIP protocol itself is transmitted as plaintext, anyone who intercepts a SIP packet in transmission may know the content of the control signal. If a user wishes to keep the transmitted signal secret, then the bottom-layer network has to support the TLS protocol, or a complex cryptographic mechanism such as S/MIME will need to be used. However, such mechanism requires the support of the entire network. The security mechanism is rendered useless if any one node in the network does not support it.

In view of this, the present invention provides a method for hiding information in a SIP signal. By employing this method, a small amount of information can be hidden in the SIP signal and securely transmitted to the receiver side without the need of changing any existing SIP network nodes. The present invention also permits counterfeit detection and verification by hiding product identification codes or watermarks into the SIP signals.

### SUMMARY

In view of the forgoing background, as well as to meet interests in the industry, the present invention provides a method and apparatus for hiding information in a communication protocol signal that solves the abovementioned problems in the prior art.

One objective of the present invention is to provide a method and apparatus for hiding information in a communication protocol signal. The apparatus comprises a bit selection unit, an information encoding unit and an information decoding unit. The bit selection unit selects suitable bits in the signal for hiding information based on the signaling format. The information encoding unit selects and calculates (or encodes) the information desired to be hidden and the selected bits to obtain an encoded result. Thereafter, the originally selected bits are replaced by the encoded result to realize the signal hidden with confidential information. The information decoding unit decodes the information encoded in the suitable bits.

By employing the abovementioned method and apparatus for hiding information in a communication protocol signal, a small amount of information can be hidden in the SIP signal and securely transmitted to the receiver side without the need of changing any existing SIP network nodes. The present invention also permits counterfeit detection and verification by hiding product identification codes or watermarks into the SIP signals.

### BRIEF DESCRIPTION OF THE DRAWINGS

FIGS. 1A and 1B are schematic flowcharts according to a first embodiment of the present invention;

FIGS. 2A and 2B are schematic diagrams depicting an apparatus according to a second embodiment of the present invention;

FIG. 3 is a schematic diagram depicting a SIP signal before information is hidden therein; and

FIG. 4 is a schematic diagram depicting the SIP signal after the information is hidden therein.

### DESCRIPTION

The present invention is directed to a method and apparatus for hiding information in a communication protocol signal. Detailed steps and arrangements are described below in order to fully understand the present invention. It is apparent that the implementations of the present invention are not limited to specific details known to those skilled in the art of methods and apparatuses for hiding information in a communication protocol signal. On the other hand, well-known arrangements and steps are not described in details in order not to unnecessarily limit the present invention. Preferred embodiments of the present invention are given below. However, the present invention can of course be broadly used in embodiments other than those described herein. Thus, the present invention is only limited by the appended claims.

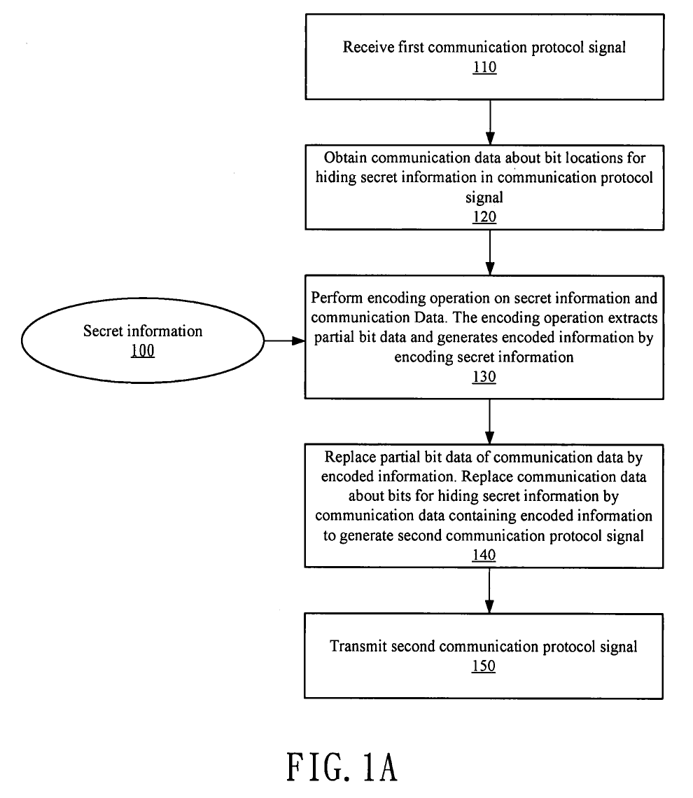

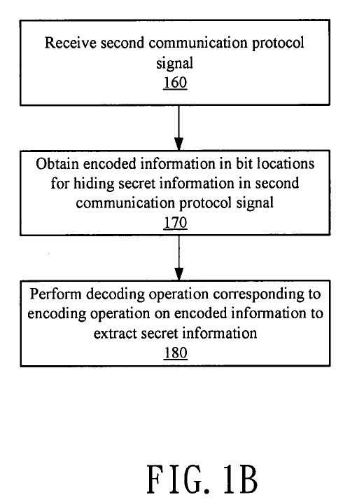

A first embodiment of the present invention provides a method for hiding information in a communication protocol signal, as shown in FIG. 1A. First, a first communication protocol signal is received in step 110. A communication data about a plurality of bit locations suitable for hiding information in the first communication protocol signal is obtained in step 120. An encoding operation 130 is performed on a piece of secret information 100 and the communication data. The encoding operation includes extracting partial bit data from the communication data, generating an encoded information by encrypting the secret information 100 with the partial bit data and replacing the partial bit data with the encoded information. The encryption herein is not limited to a specific encryption method, one can use a common encryption mechanism such as symmetric encryption (e.g. AES, DES, 3-DES, or RC4 etc.) where the key is an encrypted key, or an asymmetric encryption (e.g. DSA, RSA or Diffie-Hellman etc.), as long as it uses a key to recover data. In step 140, the communication data about the plurality of bit locations suitable for hiding information is replaced with the communication data containing the encoded information, thereby generating a second communication protocol signal. Then, the second communication protocol signal is transmitted in step 150.

As shown in FIG. 1B, the second communication protocol signal is received in step 160, and the encoded information in the plurality of bit locations suitable for hiding secret information in the second communication protocol signal is obtained in FIG. 170. Then, a decoding operation corresponding to the encoding operation is performed on the encoded information to extract the secret information 100 in step 180.

The communication data about a plurality of bit locations for hiding secret information may include “Call-ID”, “From tag”, “To tag”, “Contact”, “Route”, “Record-Route”, the branch value in “Via” header and communication data that can identify the communication during communication. The encryption step is a key encryption step.

According to a second embodiment of the present invention, the present invention provides an apparatus for hiding information in a communication protocol signal. The apparatus includes a first computer 200 and a second computer 220. The first computer 200 includes a bit selection unit 202 and an information encoding unit 204. The second computer 220 includes an information decoding unit 222.

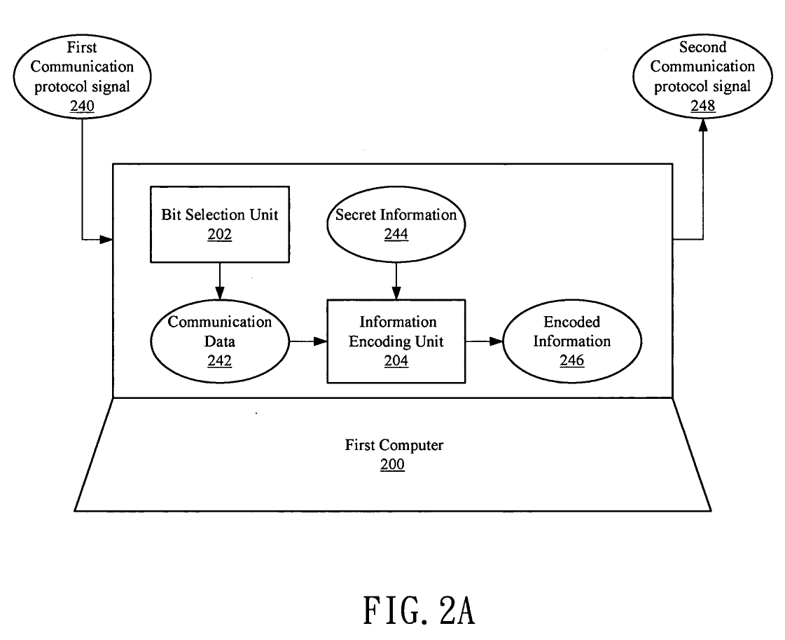

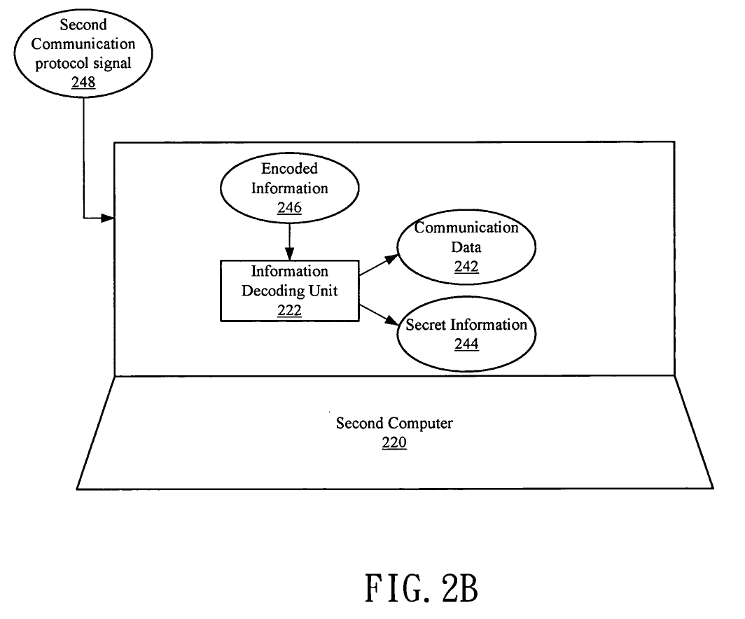

As shown in FIG. 2A, the first computer 200 is used to receive a first communication protocol signal 240. The bit selection unit 202 selects bits in the first communication protocol signal 240 suitable for hiding information based on the format of the first communication protocol signal 240, thereby obtaining a communication data 242 about a plurality of bit locations for hiding secret information in the first communication protocol signal 240. The information encoding unit 204 extracts partial bit data from the communication data 242, generates an encoded information 246 by encrypting the secret information 244 with the partial bit data and replaces the partial bit data with the encoded information 246. The secret information 244 and the partial bit data have the same bit length. The encryption herein is not limited to a specific encryption method, one can use a common encryption mechanism such as symmetric encryption (e.g. AES, DES, 3-DES, or RC4 etc.) where the key is an encrypted key, or an asymmetric encryption (e.g. DSA, RSA or Diffie-Hellman etc.), as long as it uses a key to recover data. Thereafter, the information encoding unit 204 replaces the communication data 242 about the plurality of bit locations for hiding information with the communication data 242 containing the encoded information 246, thereby generating a second communication protocol signal 248. Then, the second communication protocol signal 248 is transmitted by the first computer 200.

As shown in FIG. 2B, the second computer 220 is used to receive the second communication protocol signal 248, and the information decoding unit 222 obtains the encoded information 246 in the plurality of bit locations suitable for hiding secret information in the second communication protocol signal 248. Then, the information decoding unit 222 performs a decoding operation corresponding to the encoding operation of the encoded information 246 on the encoded information 246 to extract the secret information 244.

The communication data about a plurality of bit locations for hiding secret information may include “Call-ID”, “From tag”, “To tag”, “Contact”, “Route”, “Record-Route”, the branch value in “Via” header and communication data that can identify the communication during communication. The encryption step is a key encryption step.

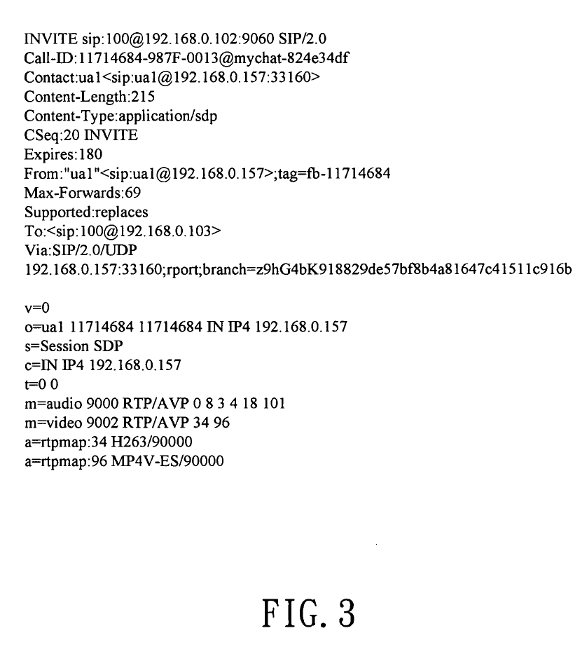

In the context of a SIP signal, a third embodiment of the present invention explains how the present invention hides information in a SIP signal. As shown in FIG. 3, in a SIP signal, most of the fields are texts having significant meaning. During transmission, a server or a user agent may use these fields to perform session control, thus the values in some of the fields may be modified along the way. Therefore, not many fields can be used to hide information. However, some fields will always exist in a SIP signal and not be modified by intermediate servers or user agents. These fields can be used to hide information, such as “Call-ID”, “From tag”, “To tag”, and branch value in “Via” header. In SIP signaling, Call-ID value can be used as identification for a session. “From tag” and “To tag” in combination with “Call-ID” can be used to identify a point-to-point session relation (i.e. a dialog). The branch in “Via” is used to identify transactions between end points. Taking “Call-ID” as an example, how the present invention hides 32-bit information S={0100 1100 0110 1111 0110 0111 0110 1111} in the “Call-ID” field of the SIP signal is described.

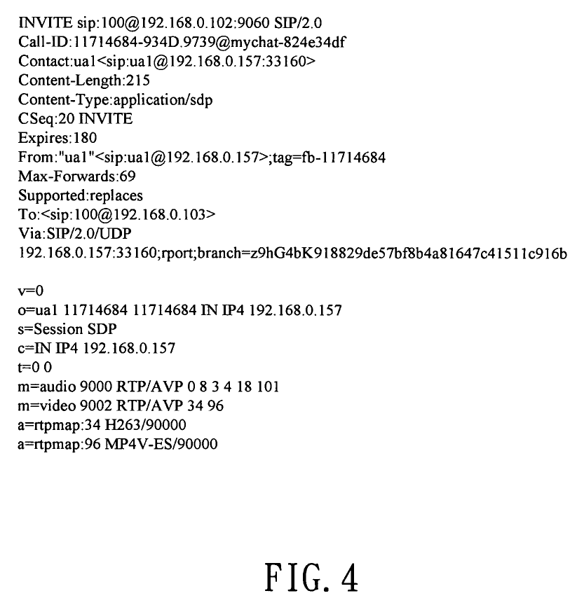

The descriptions below are provided with reference to the apparatus described in the second embodiment above. First, the bit selection unit analyses a SIP signal and selects suitable bits for hiding information. For example, after calculations, the bit selection unit selects bit locations C_{idx}={85-88, 93-96, 101-104, 109-112, 117-120, 125-128, 133-136, 141-144} in the “Call-ID” field, and their corresponding bits are C={1000 0111 1111 1110 0000 0000 0001 0011}. The bits selected by the bit selection unit here are for illustrative purpose only, and selection of bits by the bit selection unit is not limited to that shown herein. The information encoding unit encodes C into S by using an encoding function E_{key}(C, S) to obtain a set of bits Stego={0011 0100 1101 1110 1001 0111 0011 1001} with information hidden therein, wherein the encoding function E_{key} (C, S) in this example can be an encryption algorithm employing a key. Then, the selected bits in the “Call-ID” field are replaced by Stego to obtain a SIP signal with hidden information, as shown in FIG. 4.

Besides hiding confidential information, the technique provided by the present invention can also be employed to hide a product ID or a watermark in the communication protocol for counterfeit detecting and verification purposes. The third embodiment of the present invention explains how to store a product watermark in a SIP signal. First, a signature S′ can be calculated from a product identification code using Hash function, assuming that a 64-bit signature is obtained in this example. After that, the bit selection unit selects, after calculation, the last 4 bits in the last 16 bytes of the “Call-ID” field as a set of bit C′ for secret information. Herein, the bits selected by the bit selection unit are for illustrative purpose only, the selection is not limited to that shown in this example. The information encoding unit then encodes S′ into C′ using an encoding function E (C′, S′) to obtain a set of bit Stego′. For simplicity, the encoding function E (C′, S′) in this example may be a function that simply replaces C′ with S′ to obtain Stego′. It is apparent that E (C′, S′) is not limited to this exemplary function. After that, the selected bits in the “Call-ID” field are replaced by Stego′, generating a Call-ID′. Since the character coding after information is hidden may not conform to the format of SIP Call-ID, Call-ID′ can be further encoded by an encoding method such as base64, so as to obtain a “Call-ID” field with a hidden product watermark.

When the SIP signal with the hidden product watermark is transmitted in the network, nodes on the network may check its “Call-ID” field to check the existence of a product watermark, if a product watermark is found, then it means that the SIP signal is indeed sent by this specific product.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A method for hiding information in a communication protocol signal, comprising:
receiving a first communication protocol signal conforming to a Session Initiation Protocol (SIP);
obtaining a communication data in the first communication protocol signal, the communication data comprising a plurality of predefined bit locations for hiding secret information;
performing an encoding operation on a secret information and the communication data, the encoding operation including extracting partial bit data from the communication data and generating an encoded information by performing an encryption on the secret information;
replacing the communication data comprising the plurality of predefined bit locations for hiding secret information with the communication data containing the encoded information to generate a second communication protocol signal; and
transmitting the second communication protocol signal.

2. The method for hiding information in a communication protocol signal of claim 1, further comprising:
receiving the second communication protocol signal;
obtaining the encoded information in the plurality of predefined bit locations for hiding secret information in the second communication protocol signal; and
performing a decoding operation corresponding to the encoding operation on the encoded information to extract the secret information.

3. The method for hiding information in a communication protocol signal of claim 1, wherein the encoding operation is a symmetric encryption algorithm.

4. The method for hiding information in a communication protocol signal of claim 3, wherein the symmetric encryption algorithm includes one of AES, DES, 3-EDS and RC4.

5. The method for hiding information in a communication protocol signal of claim 1, wherein the encoding operation is an asymmetric encryption algorithm.

6. The method for hiding information in a communication protocol signal of claim 5, wherein the asymmetric encryption algorithm includes one of DSA, RSA and Diffie-Hellman.

7. The method for hiding information in a communication protocol signal of claim 1, wherein the plurality of bit locations for hiding secret information include “Call-ID”, “From tag”, “To tag”, “Contact”, “Route”, “Record-Route” and the branch value in “Via” header.

8. The method for hiding information in a communication protocol signal of claim 1, wherein replacing the communication data comprising the plurality of predefined bit locations for hiding secret information with the communication data containing the encoded information further comprises encoding the communication data comprising the plurality of predefined bit locations for hiding secret information with base64 encoding to generate the second communication protocol signal.

9. An apparatus for hiding information in a communication protocol signal, comprising:
a first computer for receiving a first communication protocol signal conforming to a Session Initiation Protocol (SIP), the first computer comprising:
a bit selection unit for obtaining a communication data in the first communication protocol signal, the communication data comprising a plurality of predefined bit locations for hiding secret information;
an information encoding unit for extracting partial bit data from the communication data, generating an encoded information by performing an encryption on the secret information, and replacing the communication data comprising the plurality of predefined bit locations for hiding secret information with the communication data containing the encoded information to generate a second communication protocol signal; and
an output unit for outputting the second communication protocol signal.

10. The apparatus for hiding information in a communication protocol signal of claim 9, further comprising:
a second computer for receiving the second communication protocol signal, the second computer comprising:
an information decoding unit for obtaining the encoded information in the plurality of predefined bit locations for hiding secret information in the second communication protocol signal, and performing a decoding operation corresponding to the encoding operation on the encoded information to extract the secret information.

11. The apparatus for hiding information in a communication protocol signal of claim 9, wherein the encoding operation is a symmetric encryption algorithm.

12. The apparatus for hiding information in a communication protocol signal of claim 11, wherein the symmetric encryption algorithm includes one of AES, DES, 3-EDS and RC4.

13. The apparatus for hiding information in a communication protocol signal of claim 9, wherein the encoding operation is an asymmetric encryption algorithm.

14. The apparatus for hiding information in a communication protocol signal of claim 13, wherein the asymmetric encryption algorithm includes one of DSA, RSA and Diffie-Hellman.

15. The apparatus for hiding information in a communication protocol signal of claim 9, wherein the plurality of bit locations for hiding secret information include “Call-ID”, “From tag”, “To tag”, “Contact”, “Route”, “Record-Route” and the branch value in “Via” header.

16. The apparatus for hiding information in a communication protocol signal of claim 9, wherein the information encoding unit further comprises encoding the communication data comprising the plurality of predefined bit locations for hiding secret information with base64 encoding to generate the second communication protocol signal.
